(19) United States
(12) Patent Application Publication
(10) Pub. No.: US 2003/0033162 A1
(43) Pub. Date: Feb. 13, 2003

(54) Coordinated management of contracts and services particulary for telecommunications

(76) Inventors: Sophie Houssiaux, Versailles (FR); Anne Laverriere, Paris (FR); Isabelle Lebourg, Versailles (FR)

Correspondence Address: Miles & Stockbridge, Suite 500, 1751 Pinnacle Drive, McLean, VA, 22102-3833, US

(21) Appl. No.: 10/169,584

(22) PCT Filed: Nov. 2, 2001
(86) PCT No.: PCT/FR01/03395

(30) Foreign Application Priority Data
Nov. 6, 2000 (FR) 0014154

(51) Int. Cl. G06F 17/60

(52) U.S. Cl. 705/1

(57) ABSTRACT

The management consists of constructing (S1) in object-oriented technology a service model (80) and a contract model (90); generating (S2) the service (85) and the contract (100) from the two models (80, 90) so that, at any time, a maximum number of versions, equal to at least two (85a, 85b; 100a, 100b), of each is defined; defining (S3) periods of application (88, 105) of said versions (85a, 85b; 100a, 100b); and defining (S4) statuses (89, 106) for the versions (85a, 85b; 100a, 100b), so as to determine, at any time, a coordination between a service version (85a) and a contract version (100a). This method allows for fully automatic management and ensures easy adaptation and fast and reliable continuity of the versions.

### TECHNICAL FIELD

The invention relates to a method for coordinated management of services and contracts. It concerns any service having at least one technical component and referring to a technical contract. The invention will be illustrated by a typical and particularly restrictive example relating to a service provided by a telecommunications operator to a customer, which can be a natural person or a legal entity. The technical contract in this case relates to quality criteria associated with thresholds and relating to the telecommunication technology that corresponds to the service.

Another subject of the invention is a computer system for implementing the method for managing the service and the contract. In particular, a telecommunication service can use technical components from different types of technologies and can require continuous monitoring with respect to various quality criteria of the technical contract. In such a case, the management method requires highly responsive and high-performance means, such as those used to manage an information system. Hence, the invention also relates to a system for managing an information system, used to implement the method for managing the service and the contract. Its other subjects are a computer program for implementing the method of the invention and a medium for recording the program, such as a CD-ROM.

### PRIOR ART

Over time, the service and the corresponding contract may be subject to more or less substantial, and more or less frequent, modifications. These modifications pose the serious problem of maintaining consistency between the service and the contract. The importance of the problem is clear in the following example.

The Telemanagement Forum classifies the management functions of telecommunications operators into three categories, respectively related to Service Fulfillment, Service Assurance and Billing. Service fulfillment can include an order for the service by the customer, the design of the communication infrastructure and the configuration of the network equipment, and the activation of the service. The assurance of a service as sold includes communication infrastructure monitoring and quality of service control. Billing for a service can be done based on the quality of the service rendered by the operator.

In the telecommunications field, a service is an end-to-end connection (from end point to end point) based on a given technology. Currently, it is possible to choose a telecommunication technology from among, for example, Frame Relay technology, Asynchronous Transfer Mode technology, known by the abbreviation ATM, and technology using the Internet Protocol (IP). The quality of the service is defined by a contract, known by the abbreviation SLA (Service Level Agreement), constituted by a set of quality of service criteria called SLA criteria. The SLA criteria are based on Quality of Service indicators, normally called QoS indicators. During the definition of the contract, the service provider and the customer agree to define a threshold for each SLA criterion. Quality of service control includes measuring quality and monitoring the contract. Monitoring the contract includes comparing the measurements related to the service with the threshold values defined in the contract. The threshold values related to the SLA criteria of a contract define a contract level. In other words, a contract level is a contract that defines default threshold values for the SLA criteria that are at least partly different from the values defined for the same thresholds of another contract level.

Controlling the quality of a telecommunication service requires a lot of data in a highly diversified technical field in which it is particularly necessary to accommodate the various available telecommunication technologies, the various modes of implementation offered by network equipment manufacturers, and the various possible data collection means required for the monitoring of the contract. Each technology, each communication infrastructure and each network equipment configuration is defined by many characteristics. The result is a high-level and often highly complex combination of data, given the links that can exist between the data and how fast they change.

It is therefore understood that in this field, there can be numerous, frequent and highly diverse modifications, both in the service offered and in the contract relating to each customer. The management of the service and the contract over time therefore poses a problem that is very complicated, and even more complicated when it comes to managing all of a telecommunications operator's customers. Modifications may be contractual and over time may involve various versions of a customer's contract. Some of these modifications can be technical, such as those related to quality thresholds, while others can relate the application over time of versions of the service and the contract. Other modifications can be linked to the telecommunication technologies or to their geographical installation, for example, the replacement of an obsolete router with another type of router that is much improved but that involves another type of service and other quality thresholds that must be reflected in the contract. Some of these modifications can relate to the application of the contract and the service over time. Modifications of the service therefore result in several versions of the service. Some versions of a service can apply to the same version of a contract, while others require a strict technical and time correspondence between a version of a service and a version of the contract, such as for example the one related to the router change. These examples clearly illustrate the problem linked to the possible overlapping of service versions and contract versions and the very high risk of their being inconsistent or of a break in continuity between the contract and the service. It is understood that the consequences of their being inconsistent can be very serious for the operator and its customers. The customers can have connection, billing and quality control problems, and the operator can thus lose some of its customers and its credibility.

At present, the coordinated management of services and contracts over time has not been fully automated. The great complexity of the problem, and the vigilance required to minimize any risk of inconsistency in the monitoring of modifications, requires a lot of personnel. Moreover, in addition to the cost in equipment and personnel, there is a substantial slowness to the management that is poorly adapted to frequent modifications, and not very responsive to operators' and customers' wishes.

### SUMMARY OF THE INVENTION

A first object of the invention is to offer a fully automated method for the coordinated management over time of services and the corresponding contracts.

A second object of the invention is to make it possible to quickly and reliably adapt the management method to any modification relating to the technical components of the service.

A third object is to ensure continuity and consistency in the application of modifications between the service and the contract over time.

A fourth object of the invention is to allow the management method to select the service modifications that involve modifications of the contract and to automatically reflect them in the contract.

A fifth object of the invention is to implement the management method using simple, inexpensive, highly responsive, and easy-to-use means.

The first subject of the invention is a method for the coordinated management of a service that includes at least one technical component and a technical contract corresponding to the service, characterized in that it comprises the following steps: constructing, in object-oriented technology, a service model and a contract model; generating the service and the contract from the two models so that, at any time, a maximum number of versions, equal to at least two, of each is defined; defining periods of application of said versions; and defining statuses for the versions so as to determine, at any time, a coordination between a service version and a contract version.

The second subject of the invention is a computer system, characterized in that it implements the method defined above. The computer system can constitute a system for managing at least one resource.

The third subject of the invention is a computer program loadable into the internal memory of a computer system, characterized in that it comprises code segments for implementing the method defined above.

The fourth subject of the invention is a computer program recording medium, characterized in that it comprises a program readable by a machine of a computer system for controlling the execution of the method defined above.

### PRESENTATION OF THE DRAWINGS

FIG. 1 is a block diagram of an exemplary system for managing at least one resource, in this case an information system, the management system implementing a method for managing services provided by a telecommunications operator to its customers under the conditions defined in respective contracts.

FIG. 2 is a detailed block diagram of an exemplary structure of a management platform present in the manager of the management system represented in FIG. 1, also illustrated in the form of a block diagram of the agents that serve as interfaces with the resources of the information system.

FIG. 3 is a partial and highly schematic view of a tree representing a Management Information Base, called MIB, relating to the objects managed by the manager represented in FIGS. 1 and 2.

FIG. 4 is a diagram illustrating the steps of an exemplary method for the management, by the management system represented in FIGS. 1 and 2, of a telecommunication service and the corresponding contract.

FIG. 5 illustrates an exemplary structure of the grammar of a service model used by the method of the invention represented in FIG. 4.

FIG. 6 illustrates an exemplary structure of the grammar of an SLA model used by the method of the invention represented in FIG. 4.

FIG. 7 illustrates an exemplary structure of a quality of service indicator used by the method of the invention represented in FIG. 4.

FIG. 8 illustrates an exemplary structure of a performance indicator used by the method of the invention represented in FIG. 4.

FIG. 9 illustrates an exemplary structure of an SLA tool description model used by the method of the invention represented in FIG. 4.

FIG. 10 is a diagram illustrating an exemplary modeling of a service and a contract for implementing the method of the invention.

FIG. 11 is a diagram illustrating an example of service statuses and their links for implementing the method of the invention.

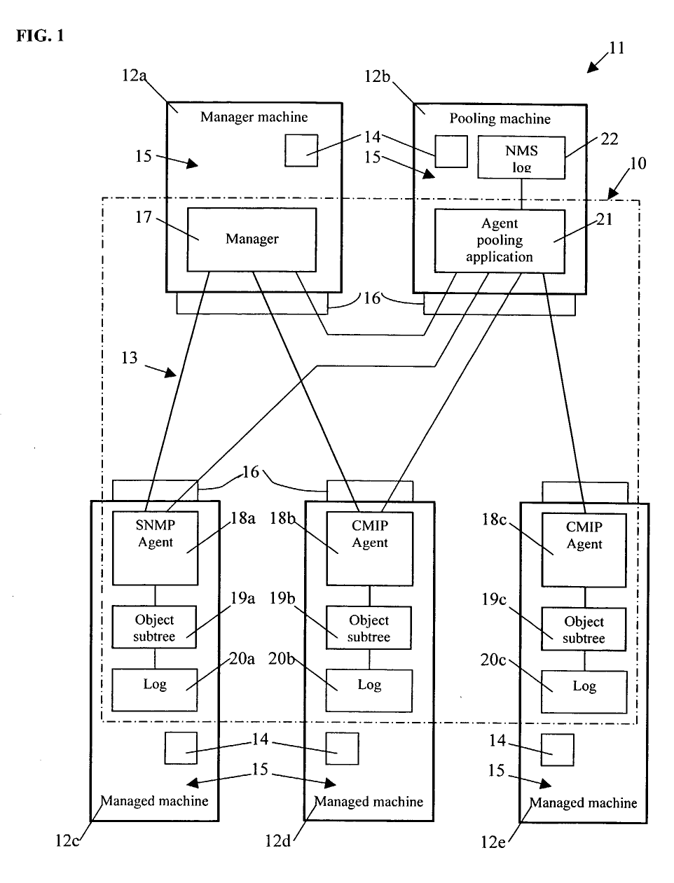

And FIG. 12 is a highly schematic view of a telecommunication structure used to illustrate an exemplary implementation of the method of the invention by the management system represented in FIG. 1.

### DETAILED DESCRIPTION OF EXAMPLES ILLUSTRATING THE INVENTION

FIG. 1 represents a management system 10 of an information system 11. The following example relates to the management and security system known by the Applicant's registered trademark OpenMaster. Its design conforms to the ISO standards for network and systems management. Under these conditions, the English-language terms used will be in accordance with this standard, including the abbreviations and acronyms. In addition, the French verbs “administrer” and “gérer” and their derivatives used herein have both been translated into the English verb “manage” and its derivatives. One skilled in the art is quite familiar with these standards. Of their total informational content, only the elements required to understand the invention will be given here.

The information system illustrated 11 is distributed and is composed of machines 12, in this case five machines 12a-12e, organized into one or more networks 13 corresponding to one or more of any protocols, preferably dedicated to management and standardized. In the example illustrated, the network 13 uses the protocol SNMP (Simple Network Management Protocol) and the protocol CMIP (Common Management Information Protocol) based on the ISO standard defining services for the transfer of management information, called CMIS (Common Management Information Services). Of course, other protocols could be used, as well as the internet network of the Web.

A machine is a very large conceptual unit that includes both hardware and software, which can be the means involved in executing a given application, means for executing a given function, a computer, as well as an information system in a cascaded systems architecture. The machines 12 can therefore be quite diverse, such as workstations, servers, routers, specialized machines and gateways between networks. The example chosen assumes that the machines illustrated are dedicated to monitoring the quality of telecommunication services and specifically incorporate routers.

The information system 11 is ordinarily a system comprising several processors 14, one processor 14 for example being illustrated in each machine 12, storage means 15 for containing the software and the data of the system, and input-output means 16 used for communication between machines via the network 13, as well as for one or more external communications, for example for printing, faxing, etc. Such a system can, for example, manage data remotely, distribute data, remotely control the execution of programs in specialized machines, locally share physical or logical resources, and communicate. More generally, the system 11 is composed of real or virtual hardware and/or software resources, such as machines, printers, virtual circuits, networks and applications. The management system 10 uses at least one of these resources in accordance with an object-oriented technology, well known to one skilled in the art.

The management system 10 chosen has an architecture of the client-server type. The server part manages and the client part contains the resource or resources to be managed. In the example illustrated, the server part comprises a manager 17 included in the machine 12a, called a manager machine, while the client part comprises a machine for pooling agents 12b, called a pooling machine, and three agents 18 (18a-18c) that allow access to the resources to be managed contained in the respective machines 12c-12e, called managed machines. The managed resources in the machines 12c-12e are identified in the form of objects organized into respective subtrees 19 (19a-19c). In the managed machines 12c-12e, the resources 19a-19c include respective logs 20 (20a-20c) containing quality of service indicators, called QoS indicators. The pooling machine 12b chosen contains a pooling application 21 and a log 22. The pooling application 21 is a network management system type of application, better known by the name NMS (Network Management System). It is responsible for pooling, in the log 22, also called an NMS log, the data contained in the local logs 20 related to the monitoring of the quality of the telecommunication services used in the managed machines 12c-12e. Consequently, the pooling application 21, like the manager 17, is linked to the agents 18 (18a-18c) via the network 13. It is also linked via the network 13 to the manager 17. Thus, to obtain the desired data, the manager 17 can access the agents 18 directly and/or indirectly through the pooling machine 12b. For example, the manager 17 can obtain data directly from the managed machines 12c and 12d and indirectly from all three managed machines 12c-12e via the pooling machine 12b. To facilitate the description, it will hereinafter be assumed that the manager 17 uses the pooling machine 12b to obtain all of the data related to the quality control of the telecommunication services. The pooling machine 12b therefore behaves like an agent 18 in relation to the manager 17, for all of this data.

Generally, the manager 17 analyzes and acts on the environment to be managed. It responds to requests from users by sending them to the managed resource in question. An agent 18, like the pooling machine 12b, is a responsive interface, assigned to a given communication protocol, with at least one manager 17 via the associated network 13. It waits for and processes the requests that the manager sends it. It maintains and updates the data contained in the corresponding subtree 19 of the managed machine 12. Conversely, a resource can send a response to a request from the manager. This response is transmitted to the manager by an agent. In addition, a managed object in a resource can send notifications to an agent for the manager. According to the ISO standard, a notification is a message that is not solicited by a manager. The standard defines an event as a type of notification, and an alarm as a type of event. In order to simplify the description and the drawings, the three managed machines 12c-12e have only been provided with three respective agents 18a-18c. According to a common and advantageous option of the management system 10, a manager 17 also manages the corresponding manager machine 12, or more generally, manages all or some of the manager machines that can exist in the management system. This can be done in a way similar to that illustrated, more or less adapted to this option. The example illustrated offers the dual advantage of facilitating the reading of the drawings while allowing one skilled in the art to generalize the system described and illustrated.

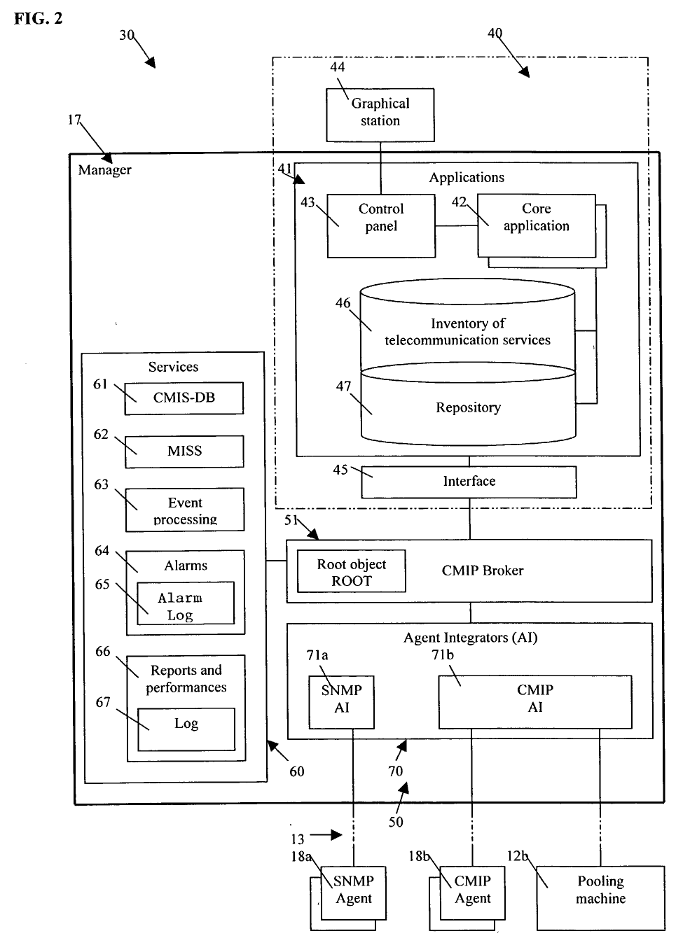

FIG. 2 illustrates the structure of a management platform 30 of the management system 10. The platform 30 is contained in the manager machine 12a and thus corresponds to the manager 17. However, in a management system with several managers, the platform 30 could be distributed among all or some of them. The platform 30 is composed of two units 40 and 50. The unit 40 contains a block 41 containing a set of applications 42 connected to a control panel 43. The applications can be written in one or several languages, the Java® language in the Applicant's OpenMaster® platform. The control panel 43 is conventional and includes a graphical part and a request launcher. A graphical station 44, outside the platform 30, is connected to the control panel 43 in order to display the applications 42, launch the requests and display the results contained in the responses. It allows a user to connect to the machine 12a in order to start and stop his own copies of the applications 42 as desired. The system 40 includes interface means 45 and, in the block 41, a database 46 constituting an inventory of the telecommunication services used in the information system 10 and a repository 47 also constituting a database. The inventory 46 and the repository 47 are linked to an application 42 dedicated to controlling the quality of the telecommunication services contained in the inventory 46. The system 40 can form an autonomous unit delimited by a broken line and constituting a management station.

In the case where the system 40 constitutes a management station, the system 50 forms a management server. The server 50 uses only one given protocol, in this case the protocol CMIP. It comprises three functional blocks: a communication block 51, also called a CMIP broker or CMIS dispatcher; a CMIS services block 60; and an interface block 70 that interfaces the platform 30 with the pooling machine 12b and the agents 18a and 18b of the resources managed directly by the platform. The broker 51 is connected to the interface means 45 of the station 40, as well as to the blocks 60 and 70 of the server 50, in order to process the requests and their potential responses, as well as the notifications issued by the agents 18a and 18b and by the pooling machine 12b. The broker 51 contains the root object ROOT to which all the objects managed by the platform 30 are attached. The block 60 contains all of the services common to the applications 42, including: a CMIS database CMIS-DB 61; a management information schema service MISS 62 containing the schemas, also called the classes, of the objects managed by the platform; an event processing service 63; an alarm service 64 incorporating an alarm log 65; and a report and performance service incorporating a log 67 and used by the performance applications 42, and more particularly by the control application 42, to evaluate the performance of the contract and produce reports. The block 70 illustrated includes two interfaces 71a and 71b which, in the example chosen, are respectively linked via the network 13 to the agent 18a and to the pooling machine 12b and the agent 18b, and are ordinarily called agent integrators or AI. Several sets of agents 18a and 18b outside the platform 30 are illustrated in order to indicate that in practice, all or some of the agents can manage distributed objets in the information system and can be located in several machines 12 of the information system 11, a machine being able to incorporate several agents using different protocols.

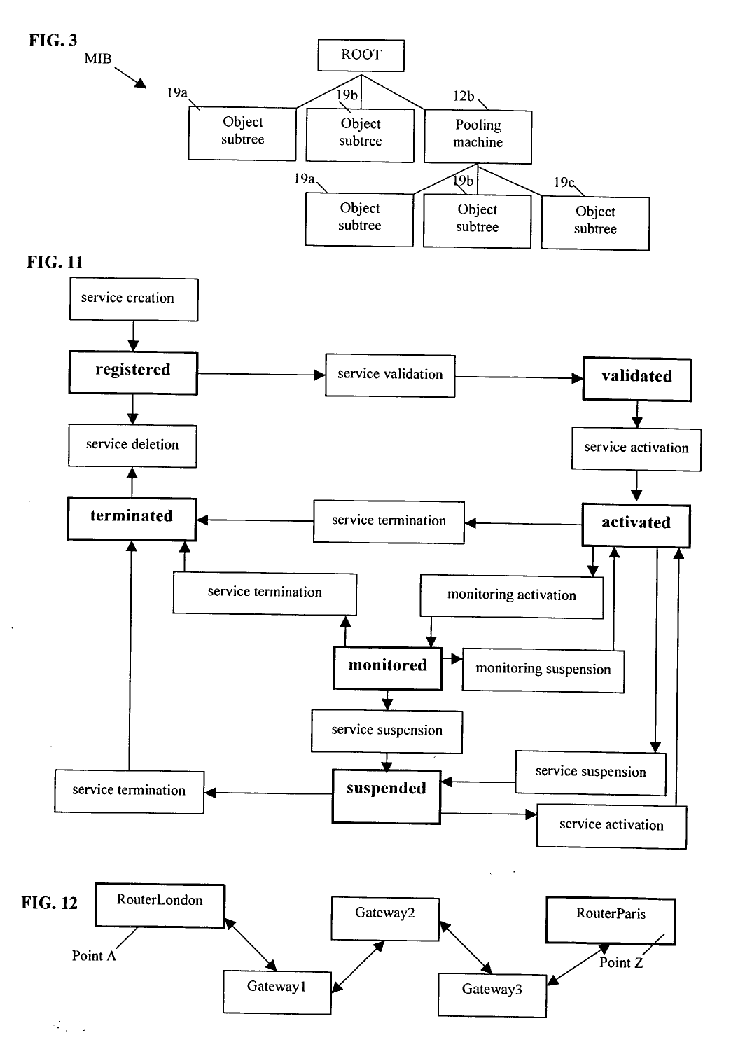

FIG. 3 illustrates, in partial and highly schematic fashion, an exemplary structure of a base MIB of objects that are managed by the platform 30 constituting the manager 17 of the management system 10 and that represent at least one resource of the information system 11. The managed resources are converted into object classes organized hierarchically in a management information base MIB. This base is not a data base per se, but is similar to a catalogue of characteristics since it contains the description and the contents of all the classes managed by the management system 10. A class is defined by characteristics called attributes, such as a name of a component of the system and a print status. An object of a class is an instance of the class. The organization of the classes in the chosen example of the management system 10 is hierarchical. It distinguishes between the class tree, a class being defined as subordinate to one or more mother classes, and the instance tree, an instance being attached to one or more mother instances. The class tree is contained in the service MISS 62, while the instance tree is the tree corresponding to the base MIB, as represented in FIG. 3. In the base MIB, the objects are divided into managed object classes, called MOCs. A managed object is an abstract view, defined for the purpose of managing a logical or physical resource of a system. Each class MOC can be attached to one or several managed object instances MOI, which represent actual occurrences of said means.

All the objects of the base MIB in FIG. 3 are located under the root ROOT and are divided into MIBlets, hereinafter called MIB modules. The root ROOT is contained in the broker 51 and the roots of the MIB modules are called rootlets. FIG. 3 illustrates two MIB modules representing two machines 12c and 12d managed by the manager 17 and corresponding to the two respective subtrees 19a and 19b, and a MIB module representing the pooling machine 12b. We have already seen that the subtrees 19a and 19b include the respective logs 20a and 20b. The pooling machine 12b, previously considered to be an agent, is a rootlet to which the respective subtrees 19a-19c are attached as sub-modules. However, the pooling machine 12b cannot be an agent. In this case, the pooling machine 12b and the three sub-modules 19a-19c would not appear in the base MIB of FIG. 3. The only function of the pooling machine 12b would then be to collect the data in the logs 20a-c of the three managed machines 12c-12e. The manager 17 would then only need to ask the pooling machine to transmit it the collected data. This case is simpler in practice and corresponds to the one chosen to implement the service quality control method according to the invention. FIG. 3 offers the advantage of illustrating a possible variant.

Likewise, in practice, a rootlet (not illustrated) is also attached under the root ROOT of the base MIB for each service of the block 60. In this bloc, the service CMIS-DB 61 provides a database for the managed objects MOI, dedicated to their persistence once the manager is shut down. It supports all the classes MOC of the CMIS services, which are stored locally in a database. Furthermore, it provides a set of basic services or functions, also called primitives, available for all the applications 42. These functions are well adapted to the hierarchical structure of the base MIB. They specifically include the following functions: M-GET for reading one or more instances, M-SET for updating one or more instances, M-CREATE for creating an instance, M-ACTION for activating a specific operation on one or more instances, and M-EVENT for sending an event.

The management system 10 serves as an exemplary support for implementing the method for coordinated management of a contract and a service provided by a telecommunications operator to a customer under the conditions defined in the contract and as defined in the introduction of the present application. A customer can be anyone, a person or a company, and the latter can be another operator. We have seen in reference to FIG. 2 that the management system 10 provides the core services to an application 42 related to the management of telecommunication contracts and services. The management system 10 illustrated, enhanced by the invention, offers telecommunications operators the advantage of managing, based on appropriate models, the services to be monitored and the quality-of-service contracts entered into between the operators and their customers on these services. It also makes it possible to generate monitoring reports on the services provided, so as to offer customers a limited and secure view.

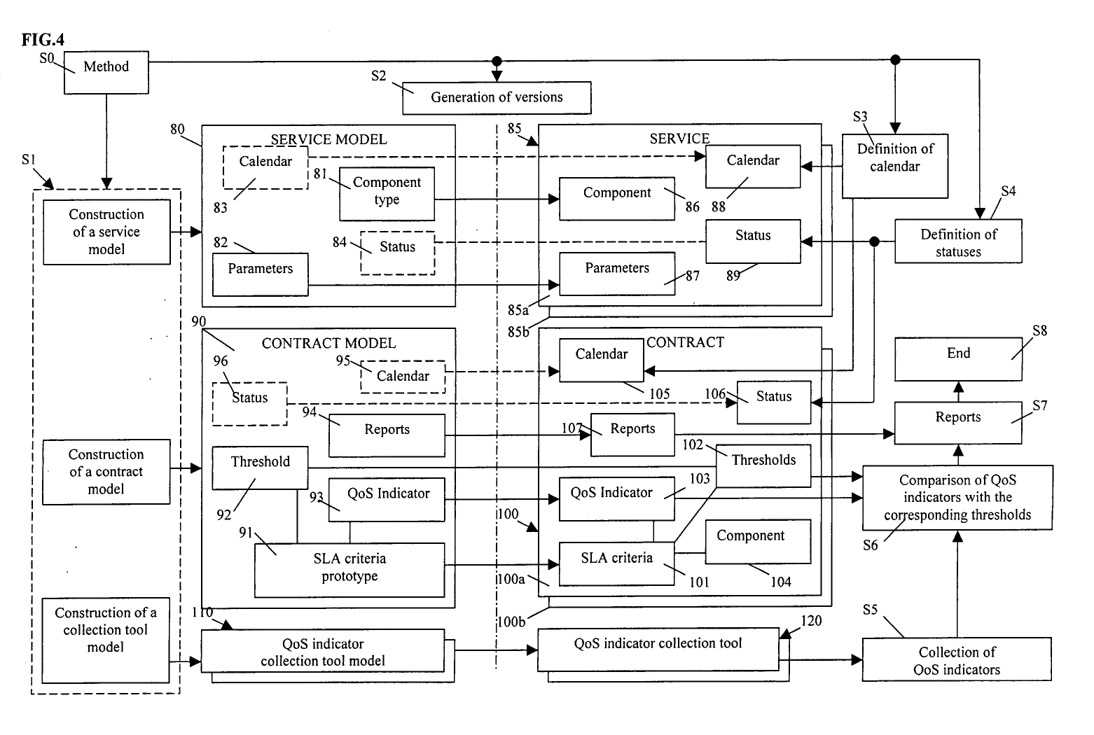

FIG. 4 is a diagram illustrating an exemplary structure of the method for the coordinated management, by means of the management system 10, of a contract and a telecommunication service implemented in the information system 11. The telecommunication services offered by the operator are contained in the inventory 46 (FIG. 2), in which the services, the customers and the corresponding contracts are identified. A telecommunication service is defined based on one of several possible telecommunication technologies. The method illustrated in FIG. 4 for managing a service and a contract is activated in a step S0 and begins with a step S1 for constructing, in object-oriented technology, a model 80 of a service related to a given technology, a model 90 of a contract related to this technology and used to define the specific contract 100 between the provider and a customer, and at least one collection tool model 110. This construction can be carried out in any manner, and more particularly in accordance with the Applicant's French Patent Application No. 00066537. In this document, the three models 80, 90 and 110 are constructed from three respective generic description structures. The set of models 80, 90 and 110 is contained in the repository 47 (FIG. 2).

More precisely, the structure of a service model is described in generic form using a service model grammar. The description is generic in the sense that it is independent of the technology and the communication infrastructure. The description of a service model structure makes it possible to define, during step S4, at least one service model 80 that conforms to the generic service model grammar, no matter what the technology involved. In the example illustrated, a service model 80 includes at least a component model 81 and a parameter model 82. The service models 80 enhance the repository 47 of the quality control method with data that makes it possible to describe the structure of a service to be monitored.

Likewise, the model structure for a contract, also called an SLA model, is described in generic form using an SLA model grammar. The contract model structure makes it possible to define at least one contract model 90, also called an SLA model. Each SLA criterion that composes a contract and is defined in the structure in generic form, i.e. independent of the technology, is called in the SLA model 90 an SLA criteria prototype 91. In an SLA model 90, each prototype 91 is linked to at least one threshold model 92 and to a single QoS indicator model 93. The SLA model can also include as an option, as illustrated, at least one model 94 of reports to be generated. An SLA model 90 created during step S5 therefore conforms to the generic grammar of the SLA model structure, no matter what technology is involved in the SLA model. The SLA models 90 enhance the repository 47 of the quality control method for different technologies, depending on the provider's needs.

Likewise, the structure of a data collection tool model that can be used to verify the SLA criteria is described in generic form by means of an SLA tool description grammar. In this case, the generic description indicates that it is independent of the technologies used by the operators and the equipment manufacturers. The structure of the collection tool model that is described by means of the SLA tool description grammar makes it possible to define at least one SLA tool model 110. Thus, the creation of an SLA tool model 110 conforms to the generic grammar, no matter what the technology, the equipment and the SLA model in question. The SLA tool models 110 enhance the repository 47 of the quality control method with data that makes it possible to automatically configure a management product in order to implement quality control on the services.

It should be noted that an SLA tool model 110 is based on the infrastructure of a defined service for a given technology with specific types of components. The infrastructure of this service is represented in the form of a service model that depends on the types of equipment that constitute its infrastructure. Thus, an SLA tool model 110 is completely dependent on an SLA model 90 and on a service model 80. Consequently, an SLA tool model 110 can only be installed if the contract model 90 and the service model 80 to which it relates have already been installed in the management system.

In summary, the invention offers three grammars for describing the three structures during step S1 of the method, i.e.:

a service model grammar for describing the structure of a model of a service to be provided, which in the telecommunications field is an end-to-end connection using a given technology and equipment types furnished by different manufacturers. This grammar can, for example, define types of end points at both ends of the connection, and parameters, including traffic parameters;

an SLA model grammar for describing the structure of a model of a contract entered into between a customer and a telecommunications operator, the description involving a set of SLA criteria for the contract and optionally, a set of models of reports to be generated; and

an SLA tool description grammar for describing a model for configuring the tools that can be used to verify compliance with the contract. These tools can be indicator collection tools or other tools involved in the quality control method. The description of the configuration of these tools must make it possible to pre-configure these tools automatically with the configuration elements they need during their execution.

These three grammars result from a choice of data to be processed. The description of the structure of these grammars is written in Unified Modeling Language UML, currently well adapted to the description of objects in object-oriented technology. The three grammars specified in UML are implemented in XML language in the form of three files. The XML language (eXtensible Markup Language) is a language for describing and exchanging structured documents. It makes it possible to describe the logical structure of documents using a system of flags that make it possible to mark the elements that compose the structure, and the relations between these elements. The XML language distinguishes between two classes of documents: well-formed documents and valid documents. A document is said to be well formed when it obeys the syntactic rules of the XML language. It can then be successfully processed by an appropriate processor, and particularly by an XML parser. A document is said to be valid when it is well-formed and when it also obeys a type of structure specifically defined in a grammar called DTD (Document Type Definition).

The management method illustrated in FIG. 4 is followed by a step S2 for generating, from the three models 80, 90 and 110, respective versions of the desired service 85, the desired contract 100 and at least one collection tool 120 required for the quality control defined by the contract 100. In other words, step S2 makes it possible to construct several services 85, several contracts 100 and several collection tools 120 from the respective models 80, 90 and 110. The service 85 contains components 86, and optionally, parameters 87, which can for example include traffic parameters in the case of a telecommunication service. The components 86 are derived from the component models 81 of the service model 80, while the parameters 87 are derived from the parameter model 82 of the model 80. The contract 100 specifically defines: the SLA criteria 101, constructed from respective SLA criteria prototypes 91; the threshold values 102 derived from at least the threshold model 92; the QoS indicators 103 related to the SLA criteria 101 and constructed from respective QoS indicator models 93; and at least one component 104 attached to an SLA criterion 101 and chosen from the components 86 of the associated service 85. Likewise, the collection tool models 110 are used to define tools 120 for collecting QoS indicators related to the SLA criteria 101 and required for the quality control of the service defined by the contract 100.

The method illustrated in FIG. 4 is included in a method for controlling the quality of the service. The control method illustrated also includes: a step S5 for collecting QoS indicators in conformity with the QoS indicators 103 of the contact 100, using at least one collection tool 120; a step S6 for comparing the QoS indicators with the corresponding thresholds 102 defined in the contract 100; and, depending on the option chosen, a step S7 for reports, in this case created based on the report models 94 that exist in the contract model 90 and are also contained in the contract 100, not illustrated in the contract 100 for purposes of clarity in the drawings. The control method illustrated ends with step S8.

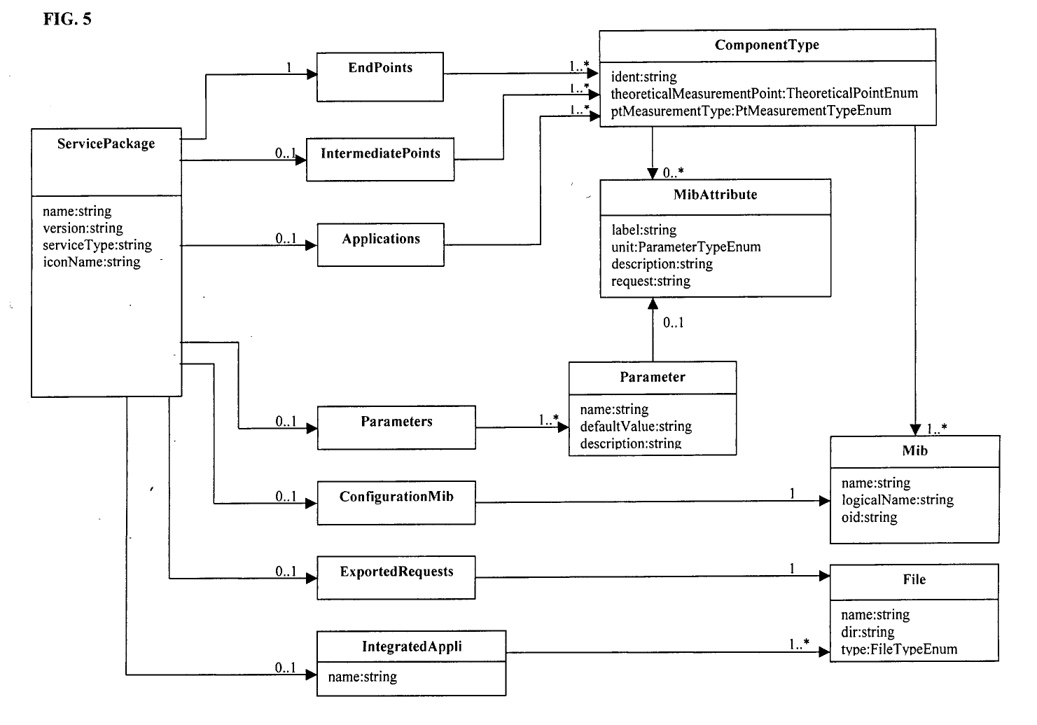

FIG. 5 illustrates-the structure of a service model 80 which, in step S1 of the method, uses a service model description grammar. The service model 80 illustrated includes at least a component model, in this case related to the various types of components 81 that can constitute the infrastructure of a telecommunications connection, and a parameter model 82. A service 85 is defined from the model 80 by specifying the components 86 and by giving the parameters 96 for the traffic configuration. The model 80 of a telecommunication service 85 is described by a class ServicePackage that has the following attributes:

name designating the name of the service model;

version designating the version of the service model;

serviceType designating the service type of the model; and

iconName designating the name of the icon representing a service.

The class ServicePackage includes the various types of components 81 useable for the service model 80. These types are grouped into three categories.

The first category represents the end points of the services in a class EndPoints. These points in the network represent the entry and exit components of the service. During the creation of the service, these components must be defined by number and by type, as described in the model. These points are indispensable to the definition of the telecommunication service 85 chosen as an example.

The second category represents intermediate points in the service in a class IntermediatePoints. These points represent intermediate network components in which the connection is supported. The model simply gives all of the possible types, but does not indicate a number of components to be defined for each type. This number varies from one service to another and can be zero. This category is therefore optional.

The third category represents the application components of the service in a class Applications. These components represent the points at which applications involved in the service, such as a billing application, are located. This category is therefore optional.

These three categories of components are based on the same description of the component types, defined in a class Component Type. The class ComponentType has the attributes:

ident designating the identifier of the component type;

theoreticalMeasurementPoint designating the theoretical measurement point of the component in accordance with a type TheoreticalPointEnum of enumeration of the theoretical measurement points, which can be the entry point of the service (pointA), the exit point of the service (pointZ) or an intermediate point of the service (pointI); and, optionally,

ptMeasurementType designating the measurement point type of the component in accordance with a type PtMeasurementTypeEnum of enumeration of the measurement point types, which can be a connection (connection), an end point (endPoint) or a logical port (logicalPort).

The class ComponentType includes at least one MIB module supported by the component and described in a class Mib. The class Mib has the attributes:

name designating the name of the directory containing the MIB module based on the rules imposed by the management system 10;

logicalName designating the logical name of the MIB module used by the management system 10; and

oid designating the identifier of the object on the highest level defined in the MIB module. The identifier “oid” (Object Identifier) is assigned uniquely throughout the world in accordance with a tree of addressing authorities defined by the ISO (International Standards Organization).

The class ComponentType also optionally includes the necessary parameters for representing the component in a class MibAttribute. The class MibAttribute has the attributes:

label designating the name of the attribute of the MIB module;

unit designating the type of the attribute of the MIB module;

description designating the description of the attribute of the MIB module; and

request designating the CMIS request that makes it possible to navigate through the MIB module of the component in question in order to access the attribute directly.

The class ServicePackage also includes, as options:

a list of parameters, including traffic parameters in the example illustrated, defined in a class Parameters;

a MIB module described in a class ConfigurationMib and making it possible to browse the traffic parameters;

a CMIS request file to be installed, described in a class ExportedRequests. These requests are used to directly access the traffic parameters defined by the class Parameters or the specific parameters of the components defined by the class MibAttribute; and

a third-party application, also called a partner application, for implementing the service, used for the service model and described in a class IntegratedAppli. While the application 42 for implementing the method is designed for the Applicant's OpenMaster® management system, a partner application is an application designed for another system.

The class Parameters contains at least one parameter described in a class Parameter that can be linked, as illustrated, to the class MibAttribute representing a pollable attribute on a component of the service. The class Parameter has the attributes:

name designating the name of the traffic parameter;

description designating the description of the parameter designated by name; and optionally,

defaultValue designating a default value for this parameter.

The class ConfigurationMib contains the MIB module required for browsing the parameters that is described in the class Mib.

The class ExportedRequests contains the CMIS request file to be installed, which is described in a class File. The class File describes a file to be processed based on its type and has the attributes:

name designating the name of the file; and, optionally,

dir designating the destination directory of the file; and

type designating the type of the file in accordance with a type FileTypeEnum of enumeration of the various possible file types, which can be an ASCII File to be copied (CopyFile), a file describing indicators to be collected (CollectFile), a file describing alarm filters (AlarmFilterFile), an ASCII export file from a CMIS request base to be imported (ImportCMISFile), a file to be executed (ExecuteFile), a file for starting the collection of the data (StartCollectFile) and a file for stopping the collection of the data (StopCollectFile), or an IDL file (IDLFile).

Finally, the class IntegratedAppli contains the description of the partner application that can be used for this service model and has the attribute name designating the name of the partner application. This class contains at least one file described in the class File;

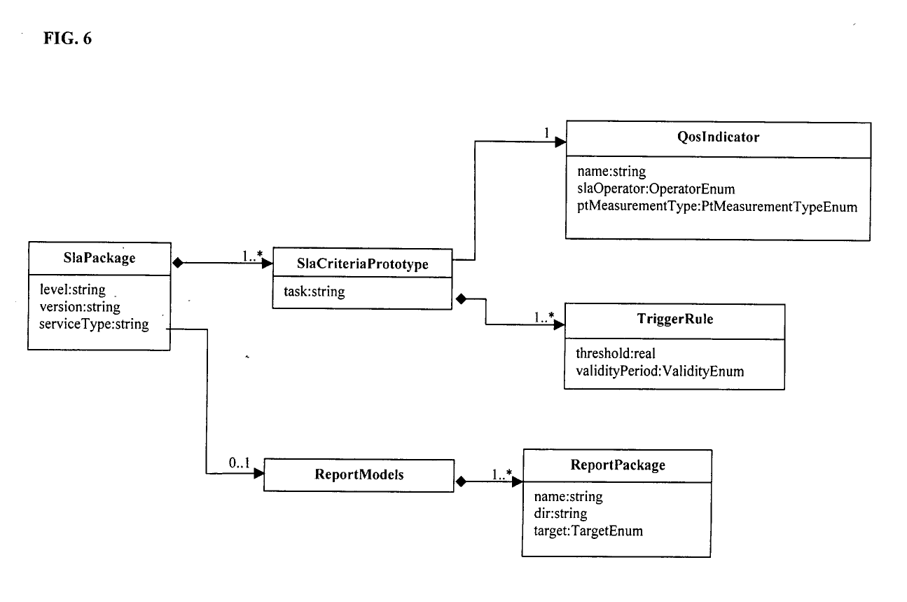

FIG. 6 illustrates the structure of a contract model 90, also called an SLA model 90, which uses the grammar for describing an SLA model during step S1 of the method. The contract 100 between the service provider and the customer is generated from the SLA model 90 in step S11. As indicated in FIG. 4, the contract 100 primarily includes SLA criteria 101, which are the objects of the quality control of the service and which are defined based on at least one SLA criteria prototype 91. An SLA criteria prototype 91 is defined as a model related to an SLA criterion for a given technology. The SLA model 90 is described by a class SlaPackage, which has the attributes:

level designating a contract level for the technology used;

version designating a version of the SLA model; and

serviceType designating a type of service.

The class SlaPackage contains at least one SLA prototype criterion 91, represented by a class SlaCriteriaPrototype, and optionally, at least one set of models 94 of reports to be generated, included in a class ReportModels. The class ReportModels includes all the models 94 of reports to be generated for all the addressee targets. A set of report models 94 is defined for each addressee target. The class ReportModels contains, by aggregation, one or more sets of models of reports to be generated per addressee target. These models are represented by a class ReportPackage, which represents a set of models of reports to be generated for a given type of addressee. It has the attributes:

name designating a name of a set of report models for an addressee target defined by the attribute target;

dir designating an installation directory for the set of report models designated by name; and

target designating a target for the set of report models, i.e., the intended user type based on a type of enumeration TargetEnum that defines the possible targets of the models of reports to be generated, which can be the billing entity (billing), the network entity (network), the service provision entity (provisioning) or the financial entity (financial).

The class SlaCriteriaPrototype contains a unique QoS indicator model 93 represented by the class QoSindicator and, by aggregation, at least one rule for triggering actions upon crossing a threshold represented by the class TriggerRule. The class SlaCriteriaPrototype has an attribute task designating the name of the task to be triggered upon crossing the threshold. A QoS indicator 103, in frame relay technology, can be the average time it takes to correct failures, known by the name MTTR (Mean Time to Repair) or the rate at which frames are delivered, known by the name FDR (Frame Delivery Ratio). The class QoSIndicator has the attributes:

name designating a name of a QoS indicator model;

slaOperator designating a default arithmetic operator, valid for a QoS indicator in accordance with an enumeration type OperatorEnum that defines arithmetic operators of superiority (>,=), inferiority, (<,=) and equality (=); and optionally,

ptMeasurementType (also defined in the class ComponentType in FIG. 4) designating the type of measurement point to which the QoS indicator relates, based on the enumeration type PtMeasurementTypeEnum, which defines measurement point types for the indicator, which can be a connection (connection), an end point (endPoint) or a logical port (logicalPort).

In practice, a QoS indicator 103 is measured at a variable frequency and is compared with a threshold 102, based on one of the arithmetic operators, in order to inform the customer when this operator is verified. For the sake of convenience, we'll say that the threshold 102 is crossed when the corresponding operator is verified. It is possible to set several additional thresholds, defining as many triggering rules as there are thresholds set, but only the first threshold is contractual. Thus, by adding, for example, one or more preliminary thresholds, it is possible to inform the customer of the approach or imminence of the condition chosen.

The class TriggerRule represents the rules for triggering actions upon crossing a threshold of an SLA criterion and has the attributes:

threshold designating an SLA criteria threshold to be monitored; and, optionally,

validityPeriod designating a validity period of a threshold in accordance with an type ValidityEnum of enumeration of the possible validity periods for a threshold, in this case a red period (red) for times corresponding to intense traffic, a blue period (blue) for times corresponding to normal traffic, and a white period (white) for times corresponding to low traffic.

Only one threshold 102 being associated with a triggering rule, there are therefore as many triggering rules as there are thresholds to be monitored. In the example illustrated, the actions to be triggered when the threshold is exceeded are performed by the service 63 contained in the platform 30 represented in FIG. 2 and used to handle the tasks of the management system 10. When the threshold for a given indicator is exceeded, an alarm is sent to the event processing service 63 waiting for this alarm. Upon receiving this alarm, the service 63 activates the task in question so as to trigger at least one action linked to the threshold exceeded, which can be, for example, the sending of an email message and the generation of reports.

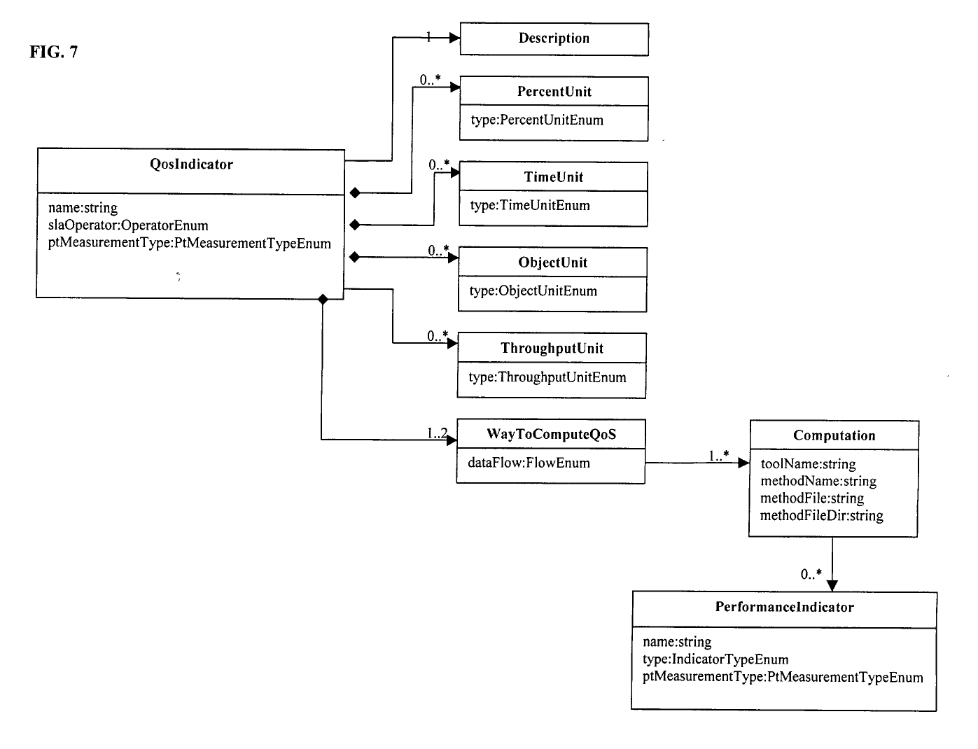

FIG. 7 illustrates an exemplary structure of a QoS indicator model 93, defined by the class QoSIndicator, which contains:

a textual description of the indicator, defined in a class Description;

at least one valid unit for this indicator, in this case chosen from the four units represented by four classes that respectively relate to units of percentage PercentUnit, time TimeUnit, objects ObjectUnit, and throughput ThroughputUnit, and

at least one and at most two modes for collecting the QoS indicator, respectively related to the two possible data flow directions and modeled by a class WayToComputeQoS. Each collection mode is associated with at least one rule for computation by a collection tool, which is represented by a class Computation. A computation rule can use parameters represented by performance indicators in a class PerformanceIndicator.

The class PercentUnit describes a unit of the percentage type and has an attribute type designating the percentage type unit chosen. The value of this attribute must conform to an enumeration type PercentUnitEnum of the possible percentage units, in this case %.

The class TimeUnit describes a unit of the time type and has an attribute type designating the time type unit chosen. The value of this attribute must conform to an enumeration type TimeUnitEnum of the possible time units, in this case microseconds (is), milliseconds (ms), seconds (s), minutes (m), and hours (h).

The class ObjectUnit describes a unit of the object type and has an attribute type designating the object type unit chosen. The value of this attribute must conform to a type ObjectUnitEnum of enumeration of the possible object units, in this case bits (bits), kilobits (kbits), bytes (bytes), kilobytes (Kb), megabytes (Mb), gigabytes (Gb), frame (frame), incident (Incident) and flow (Flow).

The class ThroughputUnit describes a unit of the throughput type and has an attribute type designating the throughput type unit chosen. The value of this attribute must conform to a type ThroughputUnitEnum of enumeration of the possible throughput units, in this case bits per second (bps), bytes per second (Bps), kilobytes per second (Kbps), packets per second (PPS), and flow per second (fps).

A QoS indicator can be computed in both data flow directions of the connection, in different ways depending on the direction. The class WayToComputeQoS has an attribute dataFlow representing the direction of the data flow according to a type FlowEnum of enumeration of the possible directions, which can be, for a connection between two end points A and Z, the directions A-Z and Z-A (A-Z, Z-A), and for a port, the receiving direction R and the transmitting direction T (R, T);

The class Computation describes a computation/retrieval rule for an indicator, the rule being written in a method and the class having the attributes:

toolName designating the name of the tool used by the method; and optionally,

methodName designating the name of the method for performing the computation/retrieval of the indicator and involving the following attributes:

methodFile designating the file containing the name of the method methodName; and

methodFileDir designating the installation directory of the file designated by methodFile. In the present case, this directory (not illustrated) is located in the manager 17.

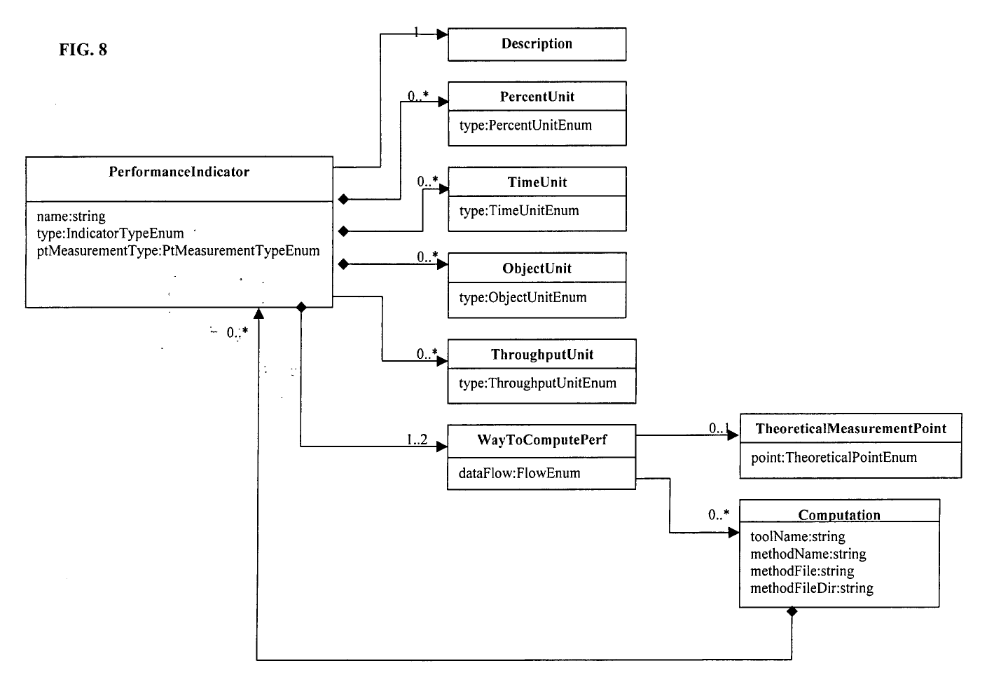

FIG. 8 illustrates an exemplary structure of a performance indicator defined by the class PerformanceIndicator represented in FIG. 7. Unlike a QoS indicator, which applies to an end-to-end connection and is subject to a contractual threshold, a performance indicator applies to a piece of network equipment and is not subject to a contractual threshold. A QoS indicator, being related to a connection, i.e., to an array of network equipment, can be an aggregation of several performance indicators. That is why the mode for computing a QoS indicator can include performance indicators as parameters. The performance indicator illustrated in FIGS. 7 and 8 is described by the class PerformanceIndicator, which has the following attributes:

name designating the name of the performance indicator:

type designating the type of the indicator according to an enumeration type IndicatorTypeEnum of the indicator types, in this case a basic indicator type (basic) and a computed indicator type (computed). A basic indicator is calculated by a collection tool, while a computed indicator is aggregated from other indicators; and

ptMeasurementType designating the type of measurement point to which a performance indicator relates, according to an enumeration type PtMeasurementTypeEnum.

The class PerformanceIndicator contains:

necessarily, a textual description of the indicator, defined in the class Description, also represented in FIG. 6;

at least one valid unit, in this case chosen from the four units represented by the classes PercentUnit, TimeUnit, ObjectUnit, and ThroughputUnit; and

at least one and no more than two modes for collecting the performance indicator, depending on the direction of the data flow.

The collection mode is modeled by a class WayToComputePerf, which has the attribute dataFlow designating a data flow direction in accordance with the enumeration type FlowEnum. As with a QoS indicator 103, the computation of a performance indicator can be performed in both data flow directions of the equipment, and in different ways depending on the direction. If the indicator is the computed type, the class WayToComputePerf can be associated with the class Computation, which defines a rule for the computation/retrieval of the indicator by the collection tool. As described above, this computation rule can optionally have other performance indicators PerformanceIndicator as parameters in the case where the performance indicator described is itself composed of other indicators. If the indicator is the basic type, it has no computation/retrieval rule, but it has a theoretical measurement point, defined by a class TheoreticalMeasurementPoint associated with the class WayToComputePerf, through which it is possible to obtain its value. The class TheoreticalMeasurementPoint describes the theoretical-measurement point of a basic type performance indicator. There is only one measurement point for an indicator. If the indicator is the computed type, there is no associated measurement point. The class has an attribute point designating the theoretical measurement point according to the type TheoreticalPointEnum.

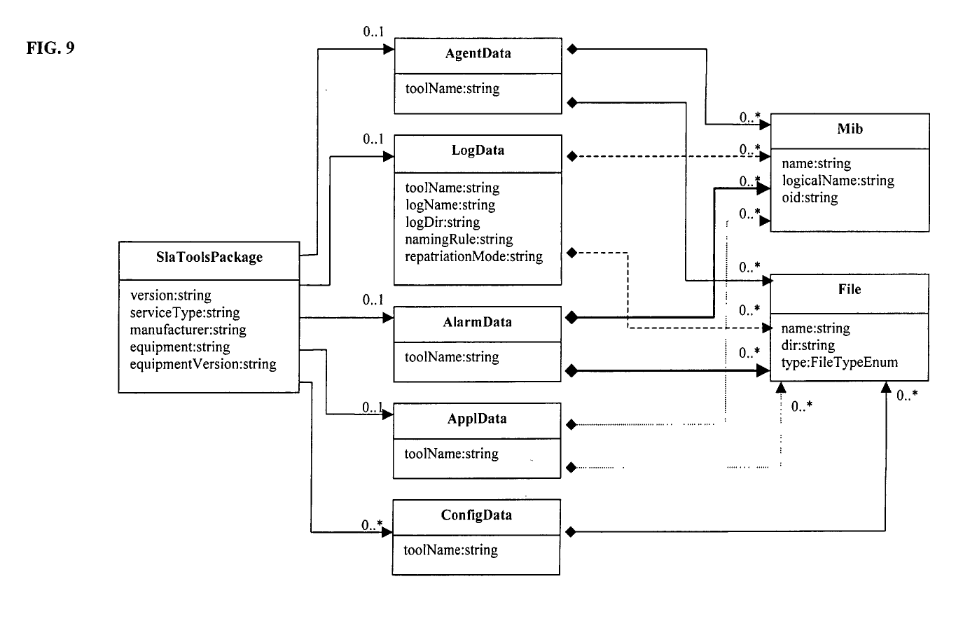

FIG. 9 illustrates the structure of a model 110 for describing at least one SLA tool 120, which uses the grammar of an SLA tool description model. An SLA tool description model 110 defines, for a given technology and a given piece of equipment, tools 120 required to measure the quality of service described in an SLA module and based on a given service model 80. The SLA tool description model 110 illustrated is described by the class SlaToolsPackage which has the following attributes:

version designating the version of the SLA tool model;

serviceType designating the type of service with which the SLA tool description model 110 is associated;

manufacturer designating the name of the manufacturer of the equipment (a router, for example) supported by this SLA tool model;

equipment designating the name of the equipment supported by this SLA tool model; and

equipmentVersion designating the version of the equipment supported by this SLA tool model.

The class SlaToolsPackage can contain, as illustrated

at least one collection mode usable for the SLA model, in this case:

an agent-based collection mode represented by a class AgentData, wherein the data comes from an agent 18;

a log-based collection mode represented by a class LogData, wherein the data comes from a log 20, 22, 67;

an alarm-based collection mode represented by the class AlarmData, wherein the data comes from filtered alarms stored in the log 65; and optionally,

a third-party application based (other than OpenMaster in the example illustrated), represented by the class ApplData and wherein the data comes from the third-party application; and

at least one application configuration description, other than the collection tools, usable for measuring quality of service and represented by the class ConfigData.

The class AgentData represents the agent 18 based collection mode of a tool. It has the attribute toolName designating the name of the agent 18. It optionally describes the configuration information required by this tool, such as the information represented by the class Mib illustrated in FIG. 4 and related to the basic Mib modules supported by the agent and that defined for the component types of the corresponding service model, and that represented by the class File illustrated in FIG. 4 and containing the automatic installation files and the collection files, in the logs 20, 22 and 67, of indicators to be installed, and preferably the configuration file or files specific to the agent.

The class LogData represents the log 20, 22, 67 based collection mode of a tool. It optionally describes the configuration information required by this tool, such as the information related to the class AgentData and contained in the classes Mib and File. The class LogData has the attributes:

toolName designating the name of the log-based collection tool;

logName designating the name of the log 20, 22, 67 of indicators collected by the tool designated by toolName;

logDir designating the directory in which the log designated by logName must be installed;

namingRule designating the rule for naming instances in the log designated by logName;

repatratriationMode designating the repatriation mode of the log designated by logName.

The class AlarmData represents the alarm-based collection mode of a tool. It has the attribute toolName designating the name of the tool collecting the alarms, for example the tool 64. It optionally describes configuration information required by the tool, such as that related to the class AgentData and contained in the classes Mib and File.

The class AppliData represents the third-party application based collection mode. It has the attribute toolName designating the name of the third-party application and optionally describes the configuration information required by this tool, such as that related to the class AgentData and contained in the classes Mib and File.

The class ConfigData represents the description of the configuration of an application outside the collection tool to be configured for implementing the quality measurement. The application to be configured can, in this case, be an OpenMaster application 42 or a third-party application. The class ConfigData has the attribute toolName designating the name of the application to be configured and optionally contains the files required for the configuration or for the automatic installation of the application.

Step S1 of the method of the invention produces a generic, exhaustive and synthetic description of the information to be supplied in order to measure and monitor the quality of service. Service models are created for a technology, independent of a quality contract. SLA models are created for a given technology, independent of the collection tools and the equipment, in order to model the various contract levels applicable to the monitoring of a service. SLA tool description models are created for a given technology and piece of equipment, in order to define the tools that can be used to verify the contract. An SLA tool description model is only installed in the management system 10 if an SLA model defining the model of the contract, and a service model defining the equipment subject to measurement, for a given technology, have already been installed. One then need only create a new SLA tool description model in order to accommodate a new piece of equipment for this technology. The description of these models then makes it possible to synthetically and exhaustively describe the information concerning the measurement and the monitoring of the quality of service of a telecommunication service.

It will be noted that in the example illustrated, the QoS indicator collection tool model 110 is simply used to monitor the quality of the service in reference to the SLA criteria and the thresholds defined in the contract. It can therefore be said that the tool model 110 is an attribute of the contract model 90. Consequently, the same is true for the tools 120, which are attributes of the contract 100. Furthermore, a contract model can only be used if at least one service model based on the same telecommunication technology is defined. Likewise, a tool model can only be used if at least one contract model based on the same telecommunication technology is defined. The service, contract and tool models therefore have the telecommunication technology as a common link. Furthermore, the contract model also has a link with the service model insofar as the types of equipment (pointA, pointI, pointZ) on which the quality indicators are collected are defined therein, these types of equipment necessarily being chosen from those defined in a service model. A contract modification does not lead to a service modification. A contract modification results either from a service modification or from a need to modify data specific to the contract (thresholds, reports) that have no impact on the service. Creating a service consists of choosing a service model and assigning the real equipment of the service to the equipment types defined in the service model. Creating a contract consists of choosing a contract model for the service previously created and of choosing, from the equipment of the service, the equipment that will be used to measure the criteria. Creating a contract can also include options consisting of modifying criteria predefined in the contract model, choosing tools, predefined in a tool model, for measuring these criteria, and choosing reports, predefined in the contract model, for reporting the measurements.

In step S2, which can be repeated over time, the operator can respectively generate, from the service model 80 and the contract model 90, a service 85 related to a given technology and a specific contract 100 related to this technology between the operator and a customer. In keeping with the remark made in the preceding paragraph, the generation of the contract 100 from the model 90 also includes the generation of tools 120 from the model 110. In step S2, the operator providing the service can over time generate several versions 85a, 85b, . . . 85m of a service 85, several versions 100a, 100b, . . . 100n of a contract 100 and several versions 120a, 120b . . . 120n of at least one given tool 120. In the example described, the tools are linked to the contract model, and changing a version of a tool for a contract that has already been created is not allowed. However, it would be possible to modify the version of a least one tool for a given contract when, in particular, the tool model is separate from the contract model. The invention more particularly concerns the coordinated management of a service and, a contract and their respective versions. In step S2 of the method of the present invention, the generation of the versions is performed so that there is always a service 85 and a contract 100, each defined by a maximum of two versions. A service and a contract that each have a given content are called a service version and a contract version. A different version of a service or a contract is defined by a content different from the given content. The different content can be a small modification, for example of the activation date, and can also be a substantial change in the service and/or the contract. However, in the example illustrated, a service is based on a given technology, so the versions of the service are always defined from the same model 90 related to the given technology.

Likewise, the method illustrated in FIG. 4 includes a step S3 for defining a calendar for determining the application over time of the versions of the service and the contract. All versions of a service 85 and a contract 100 therefore include two respective calendars 88 and 105. The calendars 88 and 105 are defined by the operator using his graphical station 44. Likewise, the method illustrated also includes a status defining step S4, in order to determine at any time a coordination between a service version and a contract version. All versions of a service 85 and a contract 100 therefore include two respective statuses 89 and 106. The statuses 89 and 106 are defined automatically at the creation of the versions, which corresponds to the registered status defined below.

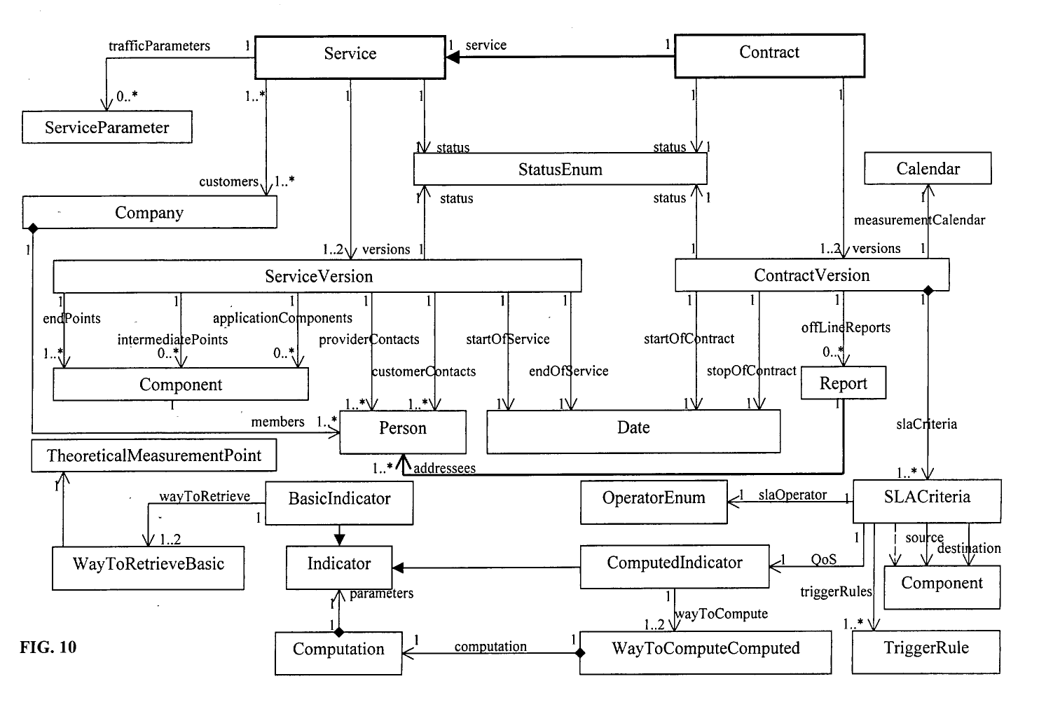

FIG. 10 is an illustrative diagram based on the unified modeling language UML, currently well adapted to the description of objects in object-oriented technology. The service 85 is represented by a class Service and the contract 100 is represented by a class Contract. The diagram illustrates the correspondence relations between these two classes.

The class Service contains:

optional traffic parameters 87, named TrafficParameters, linked to the technology and represented by a class ServiceParameter,

at least one customer in a list Customers of customers that have subscribed to the service, represented by a class Company, and

at least one version and at most two versions 85a, 85b of the service 85, represented by a class ServiceVersion.

The class ServiceVersion contains the modifiable elements of the service, i.e.:

the dates (days and times) of validity of the service, constituting the calendar 88 and including the start date StartOfService and the end date EndOfService, represented by a class Date,

at least one component 86, comprising at least one component corresponding to at least one end point EndPoints, at least one optional component corresponding to at least one intermediate point intermediatePoints, and at least one optional application component applicationComponent corresponding to the measurement of the quality of the service, represented by a class Component,

and contacts associated with the service, including at least one contact providerContacts corresponding to the employees of the provider of the service and at least one contact customerContacts corresponding to the customers that have subscribed to the service, and represented by a class Person.

The class Contract contains:

the service represented by the class Service, so that the service is an attribute of the contract, and

at least one version and at most two versions 100a, 100b of a contract 100, represented by a class ContractVersion.

The class ContractVersion contains the modifiable elements of the contract, i.e.:

the dates of validity of the contract 100, constituting the calendar 105 and including the start date startOfContract and the end date stopOfContract, represented by a class Date,

a measurement calendar measurementCalendar represented by a class Calendar;

at least one SLA criterion slaCriteria 101, all of which are represented by a class SLACriteria which has the following main elements:

an operator slaOperator represented by a class OperatorEnum,

a set triggerRules of rules to be triggered in case of noncompliance with the thresholds of the SLA criteria, represented by a class TriggerRule,

at least one measurement component 104, represented by a class Component and on which the measurements for the SLA criteria are performed. Only one component 104 is defined per type of theoretical component defined in the contract model 90. There must be at least the component representing the source (source) of the measurement direction, whose theoretical type is pointA. A component representing the destination (destination) of the measurement direction can be added, whose theoretical type is pointZ. One could extend this number of measurement points to other theoretical types of measurement points, as indicated by a broken line in FIG. 10. In other words, the component 104 is chosen so that the theoretical measurement point of the component 86 of the service 85 corresponds to the one defined in the contract model 90 for the given SLA criterion. Generally, a component 104 in the contract 100 corresponds to each type of theoretical measurement point in the contract model 90; and

an indicator QoS 103 represented by a class ComputedIndicator and specialized in the measurement direction wayToCompute (between the two points of the connection) represented by a class WayToComputeComputed, and with which is associated a computation rule computation represented by a class Computation. The computation rule uses a set of parameters parameters modeled by a class Indicator and its inherited classes, which are the computed indicator class ComputedIndicator and the basic indicator class BasicIndicator. The value of a basic indicator is retrieved for a measurement direction, represented by a class WayToRetrieveBasic, on a service component represented by its theoretical type by the class TheoreticalMeasurementPoint. The real service component is one of the measurement components previously chosen for the SLA criteria. The indicators are used to measure the service based on rules defined in the contract. The pieces of telecommunication equipment on which these indicators are collected are components of the service;

and content reports 106 defined offline offLineReport, represented by a class Report, and for which the addressees addressees represented by the class Person are defined. The addressees of the reports are necessarily persons previously defined as contacts of the service, since persons are defined not in the contract 100 but in the service 86.

The objects represented by the respective classes Service and Contract and their respective versions represented by the classes ServiceVersion and ContractVersion also have respective attributes represented by a class StatusEnum representing their administrative status status, defined below.

During step S2 of the method, at least one service version 85a and at least one contract version 100a are generated from the service, contract and tool models 80, 90 and 110. Other versions can be subsequently be generated in accordance with step S2. In this step and in the example chosen, only two versions 85a, 85b and 100a, 100b can coexist at any given time. The utilization of the versions will now be described.

In order to easily manage changes in the services and the contracts over time, versions are associated with them. At any given time, a maximum of two versions can be defined for each object constituted by a service or by a contract. A so-called “current” version represents the object in its current status, and a so-called “dormant” version represents the object in a future status. A new version is associated with an object when it is necessary to modify its definition, but not every modification of an object (a service, for example) is necessarily passed through to the other object (the contract, in this case). Therefore, at any time, we have one of the following four cases:

one service version and one contract version,

one service version and two contract versions,

two service versions and one contract version,

or two service versions and two contract versions.

The service modifications that affect the contract are passed through to the contract object 100. The passthrough is preferably done as soon as such a modification occurs, but it could be triggered by a more or less complex command. The passthrough translates into the creation of a new version of the contract. The modifications in question in the example chosen can involve the following three cases, alone or in combination:

the extension of the validity period of the service. In this case, and in the example chosen, a new version of the contract is added, with a validity period that extends that of the preceding version;

a component 86 of the service 85, used as a point for measuring a basic indicator involved in a rule for computing a QoS indicator; and

the removal of a service contact that is an addressee of a report associated with the contract.

There are two other specific cases of modifications with passthrough. The first case occurs when the contract already has two contract versions 100a and 100b and the creation of a new version 100c is requested after a service modification. In this case, the dormant contract version 100b is replaced by the new version 100c, so the planned modifications must be made later. The second case occurs when a contract modification, independent of the service, is requested, and two service versions 85a and 85b exist. In this case, a choice is made to validate the service version for which the new contract version will be created.

Each service and contract version has a validity period delimited by a start date and an end date in the respective calendars 88 and 105. FIG. 10 illustrates the correspondences of the start date startOfService and the end date endOfService between the class Service and the class ServiceVersion, as well as the correspondences of the start date startOfContract and the end date stopOfContract between the class Contract and the class ContractVersion. The management method ensures coherent correspondences between these dates. Thus, two successive service versions ensure continuous service over time. In other words, the dormant version always starts before the end of the current version. The method also ensures that the validity period of a contract is included in the validity period of the service. In the case where a contract version is only valid for one service version, the method ensures that the validity period of the contract version is included in the validity period of the corresponding service version. In all cases, the switch from the current version to the dormant version takes place automatically as a function of the validity period of the version, by accommodating the start-of-activity date of the corresponding object (service or contract).

We have seen in reference to FIG. 4 that in step S4 of the method, service and contract statuses are defined in order to determine a coordination between a service version and a contract version at any given time. The example chosen distinguishes between two status types. The first, so-called “internal,” status type relates to the service 85 and to the contract 100 as well as to the corresponding versions, and represents the status of the definitions associated with the service and with the contract. The definition of an object, in this case the service 85 or the contract 100, is the set of information that is necessary and sufficient for representing the object, and that is stored in the inventory 46 of the telecommunication services. The internal status can have two values, i.e. a value called registered, which corresponds to the registered status of the information without having been validated, and a value called validated, which corresponds to the validated status of the information and ensures that the consistency of the information has been verified and the information is registered in the base. When an object has two versions, the internal status of the object is determined by that of the current version. The second, so-called “external,” status type relates only to the service and reflects the real status of the service. In other words, the service can only have an external status if it has been validated (internal status of the current version). The external status can have any of the following four values: activated, indicating that the service is active; suspended, indicating that the service has been momentarily interrupted; monitored, indicating that the service is being monitored; and terminated, indicating that the service has been permanently stopped. The statuses registered, validated and suspended are set as a result of explicit actions on the part of an external actor, such as for example the creation and/or validation of the object via an editor, and the suspension of a service.

In the example chosen, the validation of a service makes it possible to verify: that the validity dates of successive versions ensure continuity of the service, due to the fact that the start date of a dormant service version predates the end date of the current version; that the definition of the service components 86 corresponds to elements stored in the inventory 46 of the platform 30; and that the persons defined as contacts of the service are members of the provider companies or customers of the service. It would also be possible to use the network inventory of a management platform other than the one in the example chosen (OpenMaster™) to determine the validity of a service component. During the validation of a service, the verification in the inventory of the platform illustrated is performed at the explicit request of an operator. FIG. 11 is a diagram illustrating the statuses of the service 85 and their links with one another. In the figure, the statuses are indicated in boldface characters in boxes outlined with bold lines, while their links are indicated by arrows and defined in normal characters in boxes outlined with normal lines. As illustrated, the registered status is triggered by a user of the management system 10 by means of a service creation event named service creation, and can either switch to the validated status during a validation event called service validation triggered by the user, or be cancelled by him or automatically by the application 42 of the management system 10, by triggering an event named service deletion. Likewise, the activated, monitored, and terminated statuses are automatically determined by the application 42, depending on the nature of the elements that compose the object and based on the following conditions. A service activation event, named service activation, is automatically triggered from the validated status to the activated status when the start date of the current service version is reached. A monitoring activation event, named monitoring activation, is automatically triggered from the activated status to the monitored status when the service has a contract and the start date of the current contract version is reached. In the opposite direction, a monitoring suspension event, called monitoring suspension is triggered from the monitored status to the activated status. A service termination event, named service termination, is automatically triggered from the monitored status to the terminated status when the end date of the current service version is reached. Likewise the activated status can switch directly to the terminated status with the triggering of the service termination event when the end date of the current version of the service is reached and the service does not require monitoring. This case is thus prevented from occurring, since the contract dates must always be included in the service dates, so that the monitoring always stops before the termination of the service. The terminated status automatically deletes the service by automatically triggering the service deletion event after a given time period following the termination of the service. The monitored status automatically switches to the suspended status during a service suspension event named service suspension. Furthermore, the activated status can automatically switch to the suspended status through the automatic triggering of the service suspension event, and conversely, the suspended status can be automatically reactivated so as to assume the activated status through the triggering of the service activation event. Lastly, the suspended status can automatically switch to the terminated status through the automatic triggering of the service termination event. As for the contract, we have seen that the contract 100 has only internal statuses. In fact, this is true because the contract in the example chosen is integrated into the service. Thus, the monitored status indicates that a contract is linked to the service in order to determine the monitoring criteria. This means that in other cases a contract could have external statuses. Furthermore, the validation of a contract consists of verifying: that the validity dates of the successive versions ensure both a continuity of the contract, through the fact that the start date of a dormant contract version predates the end date of the current version, and a continuity with the corresponding service, through the fact that the period delimited by the preceding two dates is included in the period of activity of the service; that the measurement points of the indicators are components defined for the service; and that the persons defined as addressees for the reports are established as contacts of the service.

The coordination between a service version and a contract version based on service and contract statuses that have been defined previously will now be described. The authorized actions on an object are conditioned by the status of the object and the associated versions. The table in Annex 1 indicates the authorized actions on the objects related to the service, as a function of service statuses that are considered to be initial statuses in the example chosen and/or of the associated versions, as well as the consequences to the status of the object. The version 85a represents the current version of the service and the version 85b represents the dormant version. At the time it is created, a service can, in case 1, simply be registered in the base or, in case 2, be subsequently validated; these two actions can also be combined into a single step. In case 3, the modification of a non-validated service always translates into the modification of the current version. Consequently, a non-validated service always has only one version. In case 4, the modification of a validated service having only one version translates into the addition of a second version, while in case 5 the modification of a validated service having two versions translates into the modification of the dormant version. Also in case 5, the second version produced after a service modification is simply registered, even when it is derived from the modification of a validated dormant version. In case 6, a service validation must be performed again after the service modification. The modification and validation actions can be combined into a single step. A service that has the activated (case 7), monitored (case 9) or suspended (case 9) status can always be modified in accordance with the established rules for a validated service. In case 10, a service that has the terminated status has been stopped permanently and cannot be modified. It should be noted that the validated status of the service always reflects the status of the current version of the service and does not take the status of the dormant version into consideration. It is therefore recommended that any service be systematically validated after modification. However, the application 42 offers a tool that makes it possible to detect any non-validated object.

The table in Annex 2 indicates the actions related to the contract that are authorized on the service objects as a function of the initial statuses of the objects, as well as the consequences to the final statuses of the objects. In case 1, a contract cannot be created on a non-validated service. In cases 2 and 3, the activation of the monitoring of the service cannot be triggered if a contract is not associated with the service, no matter what the status of the service. A contract can be created on a validated (case 4) or activated (case 5) service. In case 6, the status of the contract is registered as long as the validation step has not been performed. In case 7, the monitoring of the service cannot be triggered if the associated contract is not validated. Activating the monitoring of the service having a valid contract automatically switches it to the monitored status (case 8), unless this service is suspended (case 9). In the latter case, the service must first be reactivated in order to be switched automatically to the monitored status (case 10). Activating the monitoring is not possible in a terminated service (case 11). The termination of the monitoring is only of consequence in a monitored service (case 12). In all the other cases (case 13), the status of the service remains unchanged.

FIG. 12 illustrates an exemplary application of the method just described. Let's assume that on Jan. 15, 2000 a service subscribed to by a customer is defined by a telecommunications operator and that the service corresponds to a telecommunication between Paris and London using the IP technology defined in the introduction. On this date, the service is subscribed to for a period of six months, from Feb. 1, 2000 to Aug. 1, 2000, and is based on two end technical components represented by a point A named RouterLondon and a point Z named RouterParis. Intermediate service components for relaying the link are also referenced by the names Gateway1, Gateway2 and Gateway3. Let's also assume that a contract is associated with this service in order to measure the quality of service over a period of four months, from Mar. 1, 2000 to Jul. 1, 2000, based on two quality criteria, respectively related to the downtime of the service and the number of data packets lost. These two criteria are calculated from indicators collected at the end points of the service, RouterLondon and RouterParis. Reports are also periodically sent to all the contacts defined for the service.

A service object 85 and a contract object 100, defined by corresponding first versions 85a and 100a, are respectively generated from the corresponding models 80 and 90. These versions are registered so as to assume the registered status, then validated so as to assume the validated status Let's assume that the validity of the service version 85a begins on Feb. 1, 2000 and that of the contract version 100a begins on Mar. 1, 2000. Therefore, on January 15, there is a service object 85 having the validated status and the version 85a and a contract object 100 having the validated status and the version 100a.

On Feb. 1, 2000, the telecommunications application 42 of the management system 10 implementing the method of the invention automatically updates the status of the service with respect to its validity date and the service switches to the active status. On February 1, there is a service object having the activated status (activated) and the version 85a and a contract object having the validated status (validated) and the version 100a.

On Mar. 1, 2000, the implementation of the method of the invention automatically updates the status of the service with respect to the validity date of the contract and switches the service to the monitored status (monitored). On March 1, there is therefore a service object having the monitored status and the version 85a and a contract object having the validated status and the version 100a.

Let us now assume that during the month of March, the operator plans to replace the intermediate component Gateway2 on Apr. 1, 2000. The operator therefore performs a modification of the service so as to create and validate a new service version 85b having a validity period that runs from Apr. 1, 2000 to Aug. 1, 2000. Given that this modification does not affect the measurement of the quality criteria of the service, there is no contract modification to be performed. On March 15, there is therefore a service object having the external status monitored and two service versions 85a, 85b, each having the internal status validated, and a contract object having the validated status and the version 100a.

On Apr. 1, 2000, the telecommunication application 42 of the management system 10 automatically replaces the current service version 85a, which has become obsolete, with the dormant version 85b whose validity begins on April 1. On this date, there is therefore a service object having the monitored status and the version 85b and a contract object having the validated status and the version 100a.

Let's assume that during the month of April 2000, point A RouterLondon must be modified. The operator therefore performs a modification of the service so as to create and validate a new service version 85c having a validity period that runs from Apr. 30, 2000 to Aug. 1, 2000. Since this modification affects the measurement of the quality criteria of the service, a contract modification is therefore performed so as to create and validate a new version 100b of the contract. On April 15, there is therefore a service object having the monitored status and two versions 85b and 85c, each having the validated status, and a contract object having the validated status and two versions 100a and 100b, each having the validated status.

On Apr. 30, 2000, the telecommunication application 42 automatically replaces the current service 85b and contract 100a versions, which have become obsolete, with the dormant versions 85c and 100b, the validity of each of which begins on April 30. On this date, there is therefore a service object having the monitored status and the version 85c and a contract object having the validated status and the version 100b.

The examples described and illustrated can accommodate many variants within the capability of one skilled in the art. The method of the invention as described and illustrated constructs, in step S1, in object-oriented technology, a service model 80 and a contract model 90 that has as an attribute a model 110 for tools for controlling the quality of the service in reference to the contract. It is clear in light of the preceding description that this attribute is not necessary for the implementation of the method of the invention. The method described and illustrated also comprises the generation, in step S2, from the two models 80 and 90, of a service 85 and a contract 100. The service includes at least one technical component, and we have seen that such a component can constitute at least one correspondence link between the service 85 and the contract 100. It is clear from the preceding description that the invention can be applied to any service that includes at least one technical component, which can be physical, such as a connection in the example chosen, and/or application-oriented, as also illustrated. Any modeling language in object-oriented technology can be used. It is also clear that each structure can generate at least one respective model, and that each model can also generate at least one unit such as a service, a contract and a collection tool.

In the examples described, correspondence links are established between the validity periods of the service and the contract. More generally, a service and a contract can include characteristics other than the validity period, and at least one of the correspondence links can also apply to at least one of them, for example to the addressees for the reports. Furthermore, in the example described, the fact that the service class is included in the contract class constitutes a correspondence link. This link is necessary insofar as the contract needs elements that are specifically defined in the service, such as the technical components of the service as measuring points, or the contacts of the service as addressees for the reports. In addition, in step S2, the service 85 and the contract 100 are generated so that, at all times, a maximum of two versions of each are defined. Managing two versions of each of the models makes it possible to plan a change in a service and/or a contract and to coordinate the change in a service with the change in a contract. In particular, when for example a modification related to the service occurs in the network 13, it is passed through to the contract level, so that the measurement of the quality of service is in line with the status of the service. In the example chosen, one of the two versions constitutes a current version and the other constitutes a dormant version, preparatory to a future current version. In practice, these two versions are sufficient at all times. But it would be possible in certain cases for two alternatives to exist as dormant versions, one of which is chosen prior to becoming the current version. It would therefore be possible to manage two contract versions per service version, or four contract versions for a given service. Consequently, a maximum number of possible versions greater than two at a time is conceivable. This number of versions present at any one time should be distinguished from the number of versions that can exist over a period of time. In the latter case, we have seen above that it could normally be greater than two.

The method described and illustrated also comprises, in a step S3, a definition of the respective periods of application over time of the versions of the service 85 and the contract 100, and in a step S4, a definition of statuses related to the service and the contract for determining at any instant a coordination between a service version and a contract version. Although the statuses are different for one or the other, we have seen that this may not be the case. Briefly, internal statuses concern the service and contract versions, since they affect the validity of both objects (service and contract). External statuses concern the service object and may concern the contract object in order to decide the status of the service (activated or monitored), thus establishing a new link between the two objects (service and contract). Managing these statuses makes it possible to control, implement and monitor paired changes in the service and contract versions. Consequently, the method constantly ensures that the service and the contract are in phase with the reality of the telecommunication system 11 managed. Among the possible statuses that have been described are a registered status and a validated status. Depending on the option chosen, a contract is defined if the corresponding service is validated. More generally, a validated status, determined after verification, and at least one non-validated status, would be sufficient. In this case, one possible verification, as illustrated, relates to the inclusion of the validity period of a version of the contract in that of a version of the corresponding service, so that the version of the contract is validated for this version of the service only. The inclusion of the validity period of the contract is determined upon creation of the contract as a function of the validity period of the service, which is known at the time of inclusion, since the service is an attribute of the contract. The verification of a contract can include the verification of elements of the service that are used in the definition of the contract, such as the service components and the service contacts. At least one of the possible statuses described is an activity status of the service (activated, monitored, suspended, terminated). At least one other possible status is the one related to the monitoring of the service based on at least one criterion, such as a quality-of-service criterion QoS in the example illustrated. In the example illustrated, the calendars 88 and 105, respectively, are defined directly in the service 85 and the contract 100 during step S3. Likewise, the statuses 89 and 106 are respectively defined directly in the service 85 and in the contract 100 during step S4. However, as indicated by broken lines in FIG. 4, the calendars 88, 105 and/or the statuses 89, 106 could be defined from respective service and contract models 80 and 90 during step S2. The service model 80 contains a calendar model 83 and a status model 84, while the contract model 90 contains a calendar model 95 and a status model 96. A calendar model could define the format of the calendar to be used for the validity of the object. The basic format can include only the start date and the end date, while a more elaborate format could include several periods of application, which could be discontinuous. A status model could include a list of the possible statuses for an object and an associated status automaton. The step S1 for constructing the models 80 and 90 would then be modified accordingly.

Another subject of the invention is a computer system that implements the method of the invention. In the example chosen, the computer system is a system for managing at least one resource like those available in an information system, and can be a system and/or network and/or application resource. The management system 10 illustrated can also be applied to several operators, for example by a company having telecommunication operators as customers.

| | | Initial conditions | | Final statuses | | |
|---|---|---|---|---|---|---|
| | | Service | Number of | Service | | |
| case | Action | status | version | status | Version 1 | Version 2 |
| 1 | Creation of a | Non-existent | 0 | registered | registered | Non- |
| | service | | | | | existent |
| 2 | Validation of a | registered | 85a | validated | validated | Non- |
| | service | | | | | existent |
| 3 | Modification of a | registered | 85a | registered | registered | Non- |
| | service | | | | | existent |
| 4 | Modification of a | validated | 85a | validated | validated | registered |
| | service | | | | | |
| 5 | Modification of a | validated | 85b | validated | validated | registered |
| | service | | | | | |
| 6 | Validation of a | validated | 85b | validated | validated | validated |
| | service | | | | | |
| 7 | Modification of a | activated | 85a/85b | activated | validated | registered |
| | service | | | | | |
| 8 | Modification of a | monitored | 85a/85b | monitored | validated | registered |
| | service | | | | | |
| 9 | Modification of a | suspended | 85a/85b | suspended | validated | registered |
| | service | | | | | |

| | | | | |
|---|---|---|---|---|
| 10 | Modification of a | terminated | 85a/85b | Unauthorized action |
| | service | | | |

| | | Initial conditions | | Final statuses | |
|---|---|---|---|---|---|
| | | Service | Contract | Service | Contract |
| case | Action | status | status | status | status |
| 1 | Creation of a contract | registered | Non-existent | Unauthorized action | |
| 2 | Activation of the | validated | Non-existent | Unauthorized action | |
| | monitoring | | | | |
| 3 | Activation of the | activated | Non-existent | Unauthorized action | |
| | monitoring | | | | |
| 4 | Creation of a contract | validated | Non-existent | validated | registered |
| 5 | Creation of a contract | activated | Non-existent | validated | registered |
| 6 | Validation of a contract | validated | registered | validated | validated |
| 7 | Activation of the | activated | registered | Unauthorized action | |
| | monitoring | | | | |
| 8 | Activation of the | activated | validated | monitored | validated |
| | monitoring | | | | |
| 9 | Activation of the | suspended | validated | suspended | validated |
| | monitoring | | | | |
| 10 | Activation of the service | suspended | validated | monitored | validated |
| | after 9) | | | | |
| 11 | Activation of the | terminated | any status | Unauthorized action | |
| | monitoring | | | | |
| 12 | Termination of the | monitored | validated | activated | validated |
| | monitoring | | | | |
| 13 | Termination of the | any status | validated | unchanged | validated |
| | monitoring | except | | | |
| | | monitored | | | |

1. Method for the coordinated management of a service (85) that includes at least one technical component (86) and a technical contract (100) corresponding to the service, characterized in that it comprises the following steps: constructing (S1) in object-oriented technology a service model (80) and a contract model (90); generating (S2) the service (85) and the contract (100) from the two models (80, 90) so that, at any time, a maximum number of versions, equal to at least two (85a, 85b; 100a, 100b), of each is defined; defining (S3) periods of application (88, 105) of said versions (85a, 85b; 100a, 100b); and defining (S4) statuses (89, 106) for the versions (85a, 85b; 100a, 100b), so as to determine, at any time, a coordination between a service version (85a) and a contract version (100a).

2. Method according to claim 1, characterized in that the service (85) is defined in a class (Service) included in the class (Contract) related to the contract.

3. Method according to claim 1 or 2, characterized in that the two versions of the maximum number of versions include a current version and a dormant version, whose validity periods have a common part.

4. Method according to any of claims 1 through 3, characterized in that the service. versions (85a, 85b) and the contract versions (100a, 100b) are defined in respective classes (ServiceVersion, ContractVersion) contained in respective classes (Service, Contract) representing the service and the contract.

5. Method according to any of claims 1 through 4, characterized in that the periods of application of the versions are defined in a class (Date) common to two classes (ServiceVersion, ContractVersion) representing service and contract versions.

6. Method according to any of claims 1 through 5, characterized in that the statuses comprise a validated status (validated), determined after a verification, and a non-validated status (registered).

7. Method according to claim 6, characterized in that the contract is defined if the corresponding service is validated.

8. Method according to claim 6 or 7, characterized in that the verification is related to the inclusion of the validity period of a version of the contract in that of a version of the corresponding service, so that the version of the contract is validated for said version of the service only.

9. Method according to any of claims 6 through 8, characterized in that the verification of the contract includes the verification of elements of the service that are used in the definition of the contract.

10. Method according to any of claims 1 through 9, characterized in that at least one of the statuses represents the activity status of the service (activated, monitored, suspended, terminated).

11. Method according to any of claims 1 through 10, characterized in that at least one of the statuses (monitored) relates to the monitoring of the service based on at least one criterion defined in the associated contract, such as a quality-of-service criterion (QOS).

12. Method according to any of claims 1 through 11, characterized in that the statuses are defined in a class (StatusEnum) common to two classes (Service, Contract) representing the service and the contract, and to two classes (ServiceVersion, ContractVersion) representing the corresponding versions.

13. Method according to any of claims 1 through 11, characterized in that the application periods (88, 105) and/or the statuses (89, 106) are defined during the step (S2) for generating the service (85) and the contract (100) from respective models (83, 95; 84, 96) defined during the step (S1) for constructing the corresponding models (80, 90).

14. Computer system (10) characterized in that it implements the method defined by any of the preceding claims.

15. System according to claim 14, characterized in that it constitutes a system for managing at least one resource.

16. Computer program loadable into the internal memory (15) of a computer system (10, 11), characterized in that it comprises code segments for implementing the method according to any of claims 1 through 13.

17. Computer program recording medium, characterized in that it comprises a program readable by a machine (12) of a computer system (10, 11) for controlling the execution of the method according to any of claims 1 through 13.
